(19) United States
(12) Patent Application Publication
(10) Pub. No.: US 2019/0221054 A1
(43) Pub. Date: Jul. 18, 2019

(54) Systems And Methods For Generating Inspection Reports For A Vehicle

(71) Applicant: Laird Technologies, Inc., Chesterfield, MO (US)

(72) Inventor: Pranav Kumar, Holly, MI (US)

(21) Appl. No.: 15/872,586

(22) Filed: Jan. 16, 2018

Related U.S. Application Data
(60) Provisional application No. 62/617,456, filed on Jan. 15, 2018.

(51) Int. Cl. G07C 5/08; G07C 5/00

(52) U.S. Cl. CPC G07C 5/085; H04W 84/18; G07C 5/008

(57) ABSTRACT

According to various aspects, exemplary embodiments are disclosed of systems and methods related to generating inspection reports for a vehicle. In an exemplary embodiment, an inspection report generation system generally includes multiple wireless sensor tags, with each wireless sensor tag positioned at a different vehicle location and associated with a vehicle component included in a driver vehicle inspection report. Each wireless sensor tag includes a unique identifier. The system also includes a telematics device positioned on the vehicle, and a handheld mobile device in wireless communication with the telematics device. The handheld mobile device is configured to read the unique identifier of one of the multiple wireless sensor tags when the handheld mobile device is within a threshold distance of said one of the multiple wireless sensor tags, and to transmit the read unique identifier to the telematics device to facilitate completion of the driver vehicle inspection report.

### CROSS-REFERENCE TO RELATED APPLICATION

This application claims the benefit and priority of U.S. Provisional Application No. 62/617,456 filed Jan. 15, 2018. The entire disclosure of the above application is incorporated herein by reference.

### FIELD

The present disclosure generally relates to systems and methods for generating inspection reports for a vehicle.

### BACKGROUND

This section provides background information related to the present disclosure which is not necessarily prior art.

Driver vehicle inspection reports (DVIR) include pre-trip, post-trip, etc. reports that are created after a driver inspects key components of a vehicle. Typically, a checklist must be completed by the driver as the driver performs the inspection. In some cases, a digital checklist may be provided on a mobile device. The checklist can then be submitted wirelessly to a telematics server after inspections are completed.

### DRAWINGS

The drawings described herein are for illustrative purposes only of selected embodiments and not all possible implementations, and are not intended to limit the scope of the present disclosure.

FIG. 1 is a block diagram of a system for generating an inspection report for a vehicle, according to one example embodiment of the present disclosure;

FIG. 2 is a block diagram of the example handheld mobile device shown in FIG. 1;

FIG. 3 is a block diagram of another example system for generating an inspection report for a vehicle, including wireless sensor tags in communication with a telematics device; and

FIG. 4 is a top view of a vehicle and system for generating an inspection report for the vehicle, illustrating locations of additional wireless sensor tags.

Corresponding reference numerals indicate corresponding parts throughout the several views of the drawings

### DETAILED DESCRIPTION

Example embodiments will now be described more fully with reference to the accompanying drawings.

Digitization has reduced the need for a paper vehicle inspection report checklist, and has reduced the need to submit a physical checklist to a clerk, etc. But digitization has not reduced the risk of faking a checklist, omitting inspection of vehicle components on the checklist, etc.

Disclosed herein are exemplary embodiments of systems and methods for automating the process of generating driver vehicle inspection reports (DVIRs), to ensure that the driver inspects each vehicle component in the driver vehicle inspection report. For example, the systems and methods may increase reliability of a driver vehicle inspection report while automating the report generation and submission process.

In some cases, example systems include multiple wireless sensor tags that are each associated with different vehicle components that need to be inspected for the driver vehicle inspection report. The system also includes a handheld mobile device, which may or may not include a visual user interface, and a telematics device installed in the vehicle. The wireless sensor tags may include any suitable wireless protocol, such as radio-frequency identification (RFID) (e.g., near field communication (NFC), short range wireless communication (e.g., BLUETOOTH low energy (BLE), ZIGBEE), etc.

When the handheld mobile device is brought close to a wireless sensor tag (e.g., within a threshold proximity distance), the handheld mobile device reads a unique identifier (ID) of the wireless sensor tag. The threshold proximity distance may correspond to the type of wireless sensor protocol used, and may include any suitable threshold such as six inches, one foot, ten centimeters, etc. The handheld mobile device may then transmit the read ID of the wireless sensor tag to the telematics device via a wireless communication interface, etc.

The handheld mobile device may have a visual user interface, such as a display screen. For example, the handheld mobile device may be a cellular phone, etc. In this case, the handheld mobile device can provide feedback to the user via the user interface when a wireless sensor tag is read (e.g., detected).

Alternatively, or in addition, the handheld mobile device may include one or more light emitting diodes (LEDs) to provide feedback to a user when a wireless sensor tag is read. The handheld mobile device could optionally include a switch that enables reading the unique identifier of a wireless sensor tag when the handheld mobile device is within the threshold proximity distance of the wireless sensor tag.

In some cases, the telematics device may store a pre-loaded list of wireless sensor tag identifiers each associated with a different vehicle component to be inspected. When the telematics device receives a wireless sensor tag identifier from the handheld mobile device, the telematics device can match the received wireless sensor tag identifier to the list of identifiers. Therefore, the telematics device can track which vehicle components in the stored list have been inspected, and which vehicle components still need to be inspected to complete the driver vehicle inspection report.

The telematics device could generate the driver vehicle inspection report (DVIR) based on the received wireless sensor tag identifiers and the pre-loaded list, and then send the DVIR to a remote server (e.g., a specified server address) at a specified time. For example, the telematics device may transmit the driver vehicle inspection report to the server once the vehicle is detected as starting to move, after a specified timeout duration from receiving a first wireless sensor tag ID, etc.

In addition, or alternatively, the handheld mobile device may be configured to transmit a command to the telematics device indicating that all vehicle components have been inspected. For example, the user may be able to transmit the command when the user believes all vehicle components have been inspected such that the vehicle inspection is complete.

In some cases, the telematics device may send a signal to the handheld mobile device indicating that one or more wireless sensor tag identifiers from the pre-stored list have not yet been read. This can indicate to the user that further inspection of additional vehicle components is necessary in order to complete the driver vehicle inspection report.

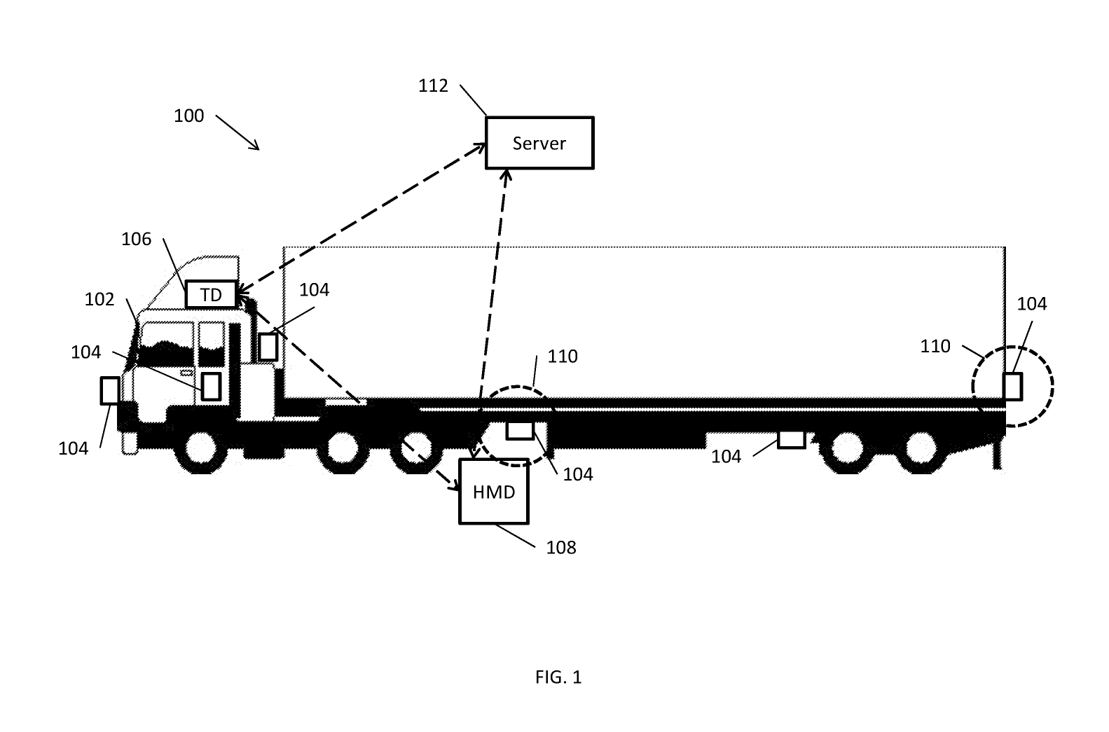

With reference to the figures, FIG. 1 illustrates an example inspection report generation system 100 for a vehicle 102, according to some aspects of the present disclosure. The system 100 includes multiple wireless sensor tags 104. Each wireless sensor tag 104 is positioned at a different vehicle location, and is associated with a different vehicle component included in a driver vehicle inspection report (DVIR). Each wireless sensor tag 104 includes a unique identifier.

The system 100 also includes a telematics device 106 positioned on the vehicle 102, and a handheld mobile device 108 in wireless communication with the telematics device 106. The handheld mobile device 108 is configured to read the unique identifier of one of the multiple wireless sensor tags 104 when the handheld mobile device 108 is within a threshold distance 110 of said one of the multiple wireless sensor tags 104. The handheld mobile device 108 then transmits the read unique identifier to the telematics device 106 to facilitate completion of the driver vehicle inspection report.

As described herein, the driver vehicle inspection report refers to any suitable report, checklist, etc. to be completed by a user regarding inspection of the vehicle 102. For example, transport companies may require drivers to complete a driver vehicle inspection report before staring a trip (e.g., pre-trip), after finishing a trip (e.g., post-trip), etc.

The driver vehicle inspection report is a digital report that may be uploaded to a remote server 112 from the telematics device 106, from the handheld mobile device 108, etc. Example vehicle components that may be part of the driver vehicle inspection report include, but are not limited to, an air compressor, air lines, a battery, brake accessories, a body, brakes, a carburetor, a clutch, a defroster, a drive line, an engine, fans, a fifth wheel, a front axle, fuel tanks, gauges (e.g., fuel, temperature), a generator, a heater, a horn, lights (e.g., headlights, stop lights, tail lights, dash lights, hazard lights, turn indicators), mirrors, a muffler, oil pressure, an on-board recorder, placards, a radiator, a rear end, reflectors, safety equipment (e.g., a backup alarm, a cell phone, emergency contact info, a fire extinguisher, a first aid kit, flags, flares, fuses, a map, reflective triangles, spare bulbs, a seal beam, seat belts, a two-way radio), springs, a starter, steering, a tachograph, a tail pipe, tires (e.g., inflation, tread, a spare), a transmission, wheels (e.g., lug nuts), windows, windshield wipers, brake connections, coupling chains, a coupling king pin, doors, a hitch, landing gear, a roof, a tarpaulin, etc. In some cases, vehicle components may be separated into vehicle categories such as a truck, a tractor, a trailer, etc.

As shown in FIG. 1, each wireless sensor tag 104 is positioned at a different location on the vehicle 102. Therefore, each wireless sensor tag 104 can correspond to a different vehicle component that needs to be inspected for the driver vehicle inspection report. The wireless sensor tags 104 may be positioned on the vehicle using any suitable attachment approach. For example, a wireless sensor tag 104 can be attached to a vehicle component to be inspected using adhesive, etc.

Each wireless sensor tag 104 may be a small form factor device. For example, each wireless sensor tag 104 could operate on a coin cell, similar to a device tile. The wireless sensor tags 104 can include any suitable wireless tag technology, including radio-frequency identification (RFID), near field communication (NFC), etc.

A wireless sensor tag 104 may include a short range wireless communication interface such as BLUETOOTH low energy (BLE), ZIGBEE, etc. This may allow the wireless sensor tag 104 to communicate with the telematics device 106, the handheld mobile device 108, etc., as described further herein.

The telematics device 106 can store a list of the unique identifiers of the multiple wireless sensor tags 104. The telematics device 106 can then match a unique identifier received from the handheld mobile device 108 to the list of the unique identifiers of the multiple wireless sensor tags 104, to determine which one of the multiple wireless sensor tags 104 was read by the handheld mobile device 108.

Matching wireless sensor tag identifiers to a stored list allows the telematics device 106 to monitor completion of the driver vehicle inspection report elements. For example, the telematics device 106 can track which components on the DVIR have been inspected, and which components still need to be inspected.

The pre-stored list of wireless sensor tag unique identifiers (IDs) in the telematics device 106 allows the telematics device 106 to determine which vehicle components and tags 104 belong to the vehicle 102 in which the telematics device 106 is installed. For example, if two vehicles are next to one another and both drivers are performing an inspection, data transmitted over a short range wireless protocol could reach both vehicles. In this case, the telematics device 106 would be able to use the stored list to verify whether the data received at the telematics device 106 was meant for the vehicle 102 belonging to the telematics device 106.

When the list is not complete, the telematics device 106 may be configured to transmit a signal to the handheld mobile device 108 indicating that at least one of the multiple wireless sensor tags 104 has not yet been read. This allows the user to continue inspecting remaining vehicle components and reading their associated wireless sensor tags 104 with the handheld mobile device 108, until the report checklist is completed.

The telematics device 106 can send the driver vehicle inspection report to the remote server 112 upon completion of the report, or at any other suitable time. For example, the telematics device 106 may be configured to send the DVIR to the remote server 112 in response to at least one of detecting movement of the vehicle 102, waiting a specified timeout period after receiving one of the unique identifiers from the handheld mobile device 108, receiving a command from the handheld mobile device 108 indicating that all vehicle components have been inspected, etc.

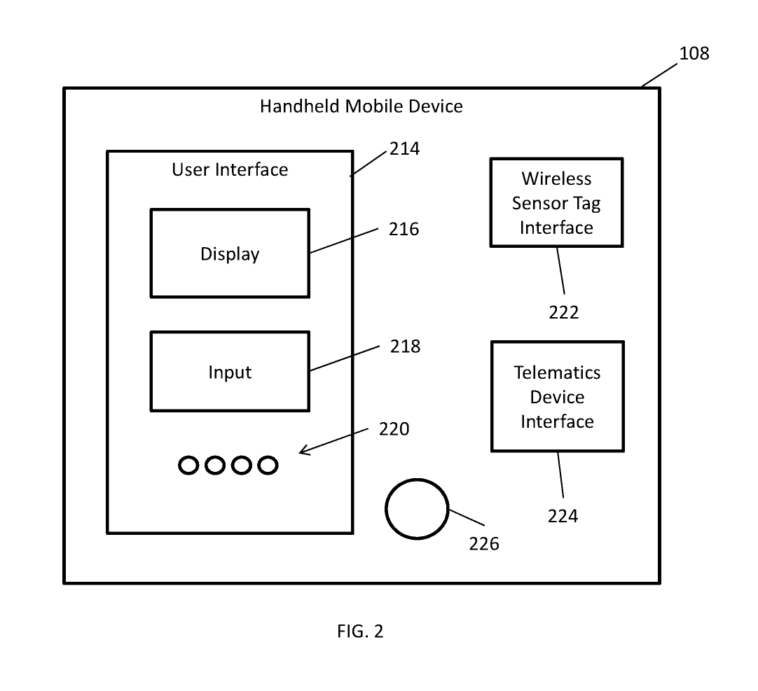

FIG. 2 is a block diagram illustrating components of the handheld mobile device 108. The handheld mobile device 108 includes a user interface 214 for receiving input (e.g., commands, etc.) from a user (e.g., driver). The user interface 214 may include a display 216, which can be any suitable display (e.g., a liquid crystal display (LCD), etc.).

Alternatively, or in addition, the user interface 214 may include one or more light emitting diodes 220 for displaying feedback information to the user. For example, the display 216 and/or light emitting diodes 220 may confirm to the user that a wireless sensor tag 104 has been read.

In some cases, a tag status could be greyed out, etc. on the display 216 until the handheld mobile device 108 is brought within the threshold distance of the wireless sensor tag 104. At that point, the handheld mobile device 108 could check the corresponding vehicle component as inspected in a driver vehicle inspection report stored in the handheld mobile device 108.

The user interface 214 may include an input 218, which can include any suitable input element(s) (e.g., a keypad, touchscreen, switches, etc.). In some embodiments, the handheld mobile device 108 may be a cellular phone, etc. In those cases, the display 216 and input 218 may be part of the same touchscreen.

The handheld mobile device 108 also includes a first wireless interface 222 for reading wireless sensor tags 104, and a second wireless interface 224 for communicating with the telematics device 106. For example, the first wireless interface 222 may be a radio-frequency identification (RFID) interface for reading RFID tags, a near field communication (NFC) interface, etc.

A user can proceed with an inspection by moving the handheld mobile device 108 within a threshold distance 110 (as shown in FIG. 1) of a wireless sensor tag 104, thereby allowing the handheld mobile device 108 to read the unique identifier of the wireless sensor tag 104 via the first wireless interface 222. The handheld mobile device 108 can then send the read unique identifier to the telematics device 106 via the second wireless interface 224.

The second wireless interface 224 may include an RF channel, a Wi-Fi interface, etc. for communicating with the telematics device 106. The second wireless interface 224 may optionally be configured for communication with the remote server 112, and/or another wireless interface (e.g., cellular) may be used for communication with the remote server 112.

The handheld mobile device 108 may include a switch 226. The switch 226 can be activated by a user to selectively enable scanning for wireless sensor tags 104. For example, a user may activate the switch 226 to scan a wireless sensor tag 104 once the user has moved the handheld mobile device 108 within a threshold distance of the wireless sensor tag 104. As described above, the threshold distance may correspond to a distance associated with an RFID protocol, an NFC protocol, etc., such as ten centimeters, one foot, etc.

Referring back to FIG. 1, the telematics device 106 may be positioned on the vehicle 102 by installing the telematics device 106 in an interior of the vehicle 102, coupling the telematics device 106 to an exterior of the vehicle 102, etc. The telematics device 106 may be any suitable telematics device configured to obtain data regarding the vehicle 102. For example, the telematics device may include a global navigation satellite system (GNSS) antenna, such as a global positioning system (GPS) antenna, for determining a location of the vehicle 102.

The telematics device 106 includes one or more wireless interfaces for communicating with the handheld mobile device 108, the remote server 112, etc. The wireless interface(s) can include a short range wireless interface, a long range wireless interface, a cellular wireless interface, etc.

The remote server 112 can include any suitable computing device capable of receiving digital driver vehicle inspection reports. In some cases, the remote server 112 may belong to a transport company, and may generate reports for an administrator, etc. based on the driver vehicle inspection report(s) received from the telematics device 106 and/or the handheld mobile device 108.

As described herein, the example telematics devices and handheld mobile devices may include a microprocessor, microcontroller, integrated circuit, digital signal processor, etc., which may include memory. The telematics devices and handheld mobile devices may be configured to perform (e.g., operable to perform, etc.) any of the example processes described herein using any suitable hardware and/or software implementation. For example, the telematics devices and handheld mobile devices may execute computer-executable instructions stored in a memory, may include one or more logic gates, control circuitry, etc.

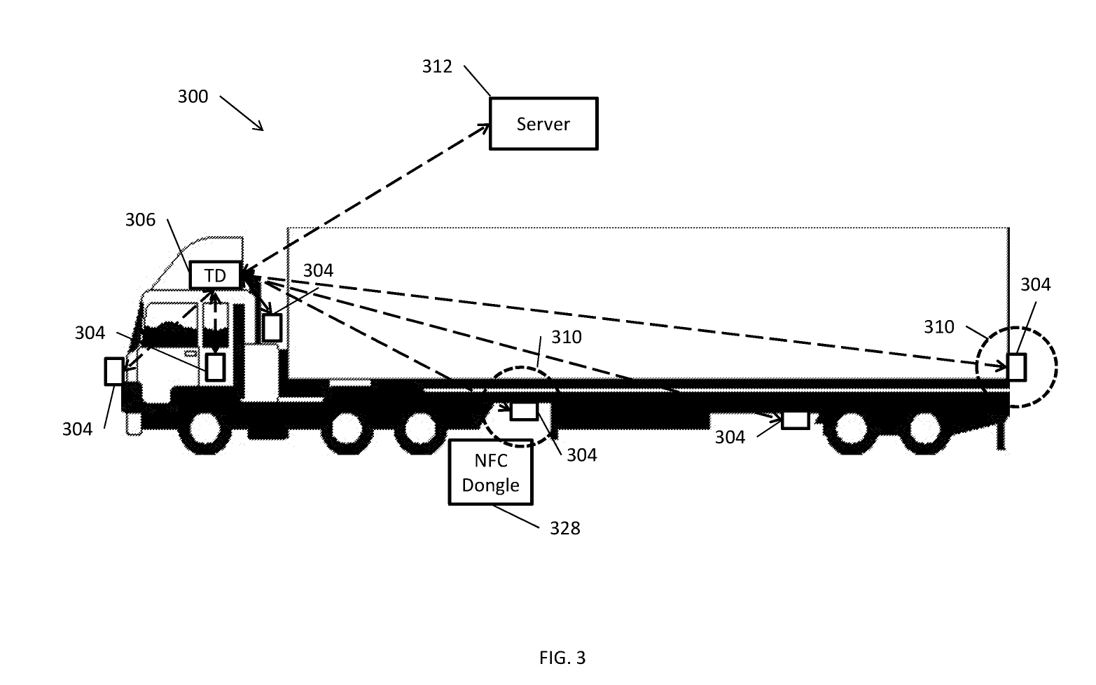

FIG. 3 illustrates an example system 300 according to another example embodiment of the present disclosure. The system 300 is similar to the system 100 of FIG. 1, but the wireless sensor tags 304 are in wireless communication with the telematics device 306. For example, the wireless sensor tags 304 may include short range wireless interface (e.g. BLUETOOTH low energy, ZIGBEE, etc.) for communicating with the telematics device 306.

The system 300 also includes a handheld device 328, which includes a wireless interface and an identifier. For example, the handheld device 328 may be an NFC dongle, etc. When the handheld device 328 is brought within a threshold distance 310 of a wireless sensor tag 304, the wireless sensor tag 304 can read the identifier of the handheld device 328.

Once a wireless sensor tag 304 reads the identifier of the handheld device 328, the wireless sensor tag 304 can transmit the identifier of the handheld device 328 and a unique identifier of the wireless sensor tag 304 to the telematics device 306. This allows the telematics device 306 to know which wireless sensor tag 304 and corresponding vehicle component was inspected by the handheld device 328, to update the driver vehicle inspection report.

The handheld device 328 may include a switch adapted to indicate a status of the vehicle component associated with the wireless sensor tag 304. For example, the switch may indicate whether the vehicle component needs attention, whether the vehicle component is in good condition, etc. This status may be read by the wireless sensor tag 304 and transmitted to the telematics device 306 to be included in the driver vehicle inspection report.

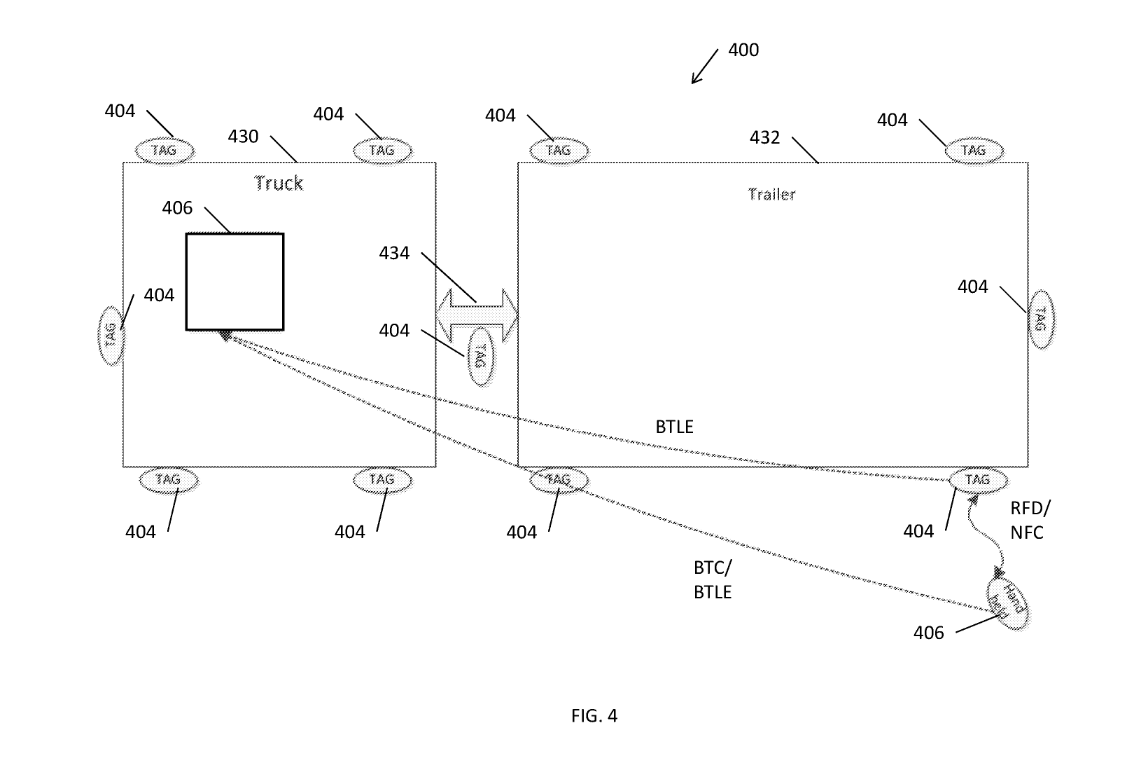

FIG. 4 illustrates a top view of an example system 400 according to another example embodiment of the present disclosure. The system 400 is similar to the systems 100 and 300 of FIGS. 1 and 3, but illustrates more wireless sensor tags 404 positioned around more locations of the vehicle 402.

As shown in FIG. 4, the vehicle 402 includes a truck 430, a trailer 432, and a coupler 434 between the truck 430 and the trailer 432. The wireless sensor tags 404 are positioned around different sides of the truck 430 and the trailer 432, and on the coupler 434. The wireless sensor tags 404 correspond to different vehicle components at the different locations on the truck 430, trailer 432 and coupler 434.

The system 400 includes a telematics device 406 positioned on the truck 430. Each wireless sensor tag 404 can communicate with the telematics device 406 using a short range wireless BLUETOOTH low energy (BLE) protocol, to transmit identifiers, etc. to the telematics device 406.

The system 400 also includes a handheld mobile device 408. The handheld mobile device 408 can read unique identifiers of the wireless sensor tags 404 via a radio-frequency (RFID) interface, a near field communication (NFC) interface, etc. The handheld mobile device 408 can then transmit data to the telematics device 406 using BLUETOOTH classic (BTC) and/or BLUETOOTH low energy (BLE) protocols.

According to another example embodiment, an exemplary method for generating inspection reports for a vehicle is disclosed. The vehicle includes multiple wireless sensor tags each positioned at a different vehicle location and associated with a vehicle component included in a driver vehicle inspection report (DVIR). Each wireless sensor tag has a unique identifier.

The exemplary method generally includes reading, by a handheld mobile device, a unique identifier of one of the multiple wireless sensor tags when the handheld mobile device is within a threshold distance of said one of the multiple wireless sensor tags. The method also includes transmitting, by the handheld mobile device, the read unique identifier to the telematics device via a wireless communication interface between the handheld mobile device and the telematics device, to facilitate completion of the driver vehicle inspection report.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purposes of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1 - 2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An inspection report generation system for a vehicle, the system comprising:
multiple wireless sensor tags, each wireless sensor tag positioned at a different vehicle location and associated with a vehicle component included in a driver vehicle inspection report, each wireless sensor tag including a unique identifier;
a telematics device positioned on the vehicle; and
a handheld mobile device in wireless communication with the telematics device, the handheld mobile device configured to read the unique identifier of one of the multiple wireless sensor tags when the handheld mobile device is within a threshold distance of said one of the multiple wireless sensor tags, and to transmit the read unique identifier to the telematics device to facilitate completion of the driver vehicle inspection report.

2. The system of claim 1, wherein the telematics device is configured to:
store a list of the unique identifiers of the multiple wireless sensor tags; and
match a unique identifier received from the handheld mobile device to the list of the unique identifiers of the multiple wireless sensor tags to determine which one of the multiple wireless sensor tags was read by the handheld mobile device.

3. The system of claim 2, wherein the telematics device is configured to transmit a signal to the handheld communication device indicating that at least one of the multiple wireless sensor tags on the list has not been read.

4. The system of claim 1, wherein the telematics device is configured to send the driver vehicle inspection report to a remote server.

5. The system of claim 4, wherein the telematics device is configured to send the driver vehicle inspection report to a remote server in response to at least one of detecting movement of the vehicle, waiting a specified timeout period after receiving one of the unique identifiers from the handheld mobile device, and receiving a command from the handheld mobile device indicating that all vehicle components have been inspected.

6. The system of claim 1, wherein the handheld mobile device includes a switch adapted to enable reading of a unique identifier of one of the multiple wireless sensor tags when the handheld mobile device is within the threshold distance of said one of the multiple wireless sensor tags.

7. The system of claim 1, wherein each wireless sensor tag comprises a radio-frequency identification tag.

8. The system of claim 7, wherein each wireless sensor tag comprises a near field communication tag.

9. The system of claim 1, wherein each wireless sensor tag comprises a short range wireless communication interface.

10. The system of claim 9, wherein the short range wireless communication interface includes at least one of a BLUETOOTH low energy wireless interface and a ZIGBEE wireless interface.

11. The system of claim 1, wherein the handheld mobile device includes a user interface.

12. The system of clam 11, wherein the handheld mobile device is configured to display a feedback indication on the user interface when the unique identifier of one of the multiple wireless sensor tags is read.

13. The system of claim 1, wherein the handheld mobile device includes one or more light emitting diodes (LEDs) configured to display a feedback indication when the unique identifier of one of the multiple wireless sensor tags is read.

14. The system of claim 1, wherein the handheld mobile device comprises a cellular phone.

15. An inspection report generation system for a vehicle, the system comprising:
a handheld device having a wireless interface and an identifier;
a telematics device positioned on the vehicle; and
multiple wireless sensor tags in communication with the telematics device, each wireless sensor tag positioned at a different vehicle location and associated with a vehicle component included in a driver vehicle inspection report, each wireless sensor tag including a unique identifier, wherein each wireless sensor tag is configured to:
read the identifier of the handheld device when the handheld device is within a threshold distance of said wireless sensor tag; and
transmit the identifier of the handheld device and the unique identifier of said wireless sensor tag to the telematics device to facilitate completion of the driver vehicle inspection report.

16. The system of claim 15, wherein the wireless interface of the handheld device comprises a near field communication wireless interface.

17. The system of claim 15, wherein each of the multiple wireless sensor tags includes a short range wireless interface, and is configured to transmit the identifier of the handheld device and the unique identifier of said wireless sensor tag to the telematics device via the short range wireless interface.

18. The system of claim 17, wherein the short range wireless interface comprises a BLUETOOTH low energy interface.

19. The system of claim 15, wherein the handheld device includes a switch adapted to indicate a status of the vehicle component associated with one of the multiple wireless sensor tags when the handheld device is within the threshold distance of said wireless sensor tag.

20. A method for generating inspection reports for a vehicle having multiple wireless sensor tags each positioned at a different vehicle location and associated with a vehicle component included in a driver vehicle inspection report, each wireless sensor tag including a unique identifier, the method comprising:
reading, by a handheld mobile device, a unique identifier of one of the multiple wireless sensor tags when the handheld mobile device is within a threshold distance of said one of the multiple wireless sensor tags; and
transmitting, by the handheld mobile device, the read unique identifier to the telematics device via a wireless communication interface between the handheld mobile device and the telematics device, to facilitate completion of the driver vehicle inspection report.
